(19) United States
(12) Patent Application Publication
(10) Pub. No.: US 2010/0296282 A1
(43) Pub. Date: Nov. 25, 2010

(54) LIGHT GUIDING MECHANISM FOR PORTABLE ELECTRONIC DEVICE

(75) Inventors: MU-WEN YANG, Shindian (TW); CHIH-CHIANG CHANG, Shindian (TW)

Correspondence Address: Altis Law Group, Inc.;ATTN: Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/702,375

(22) Filed: Feb. 9, 2010

(30) Foreign Application Priority Data
May 20, 2009 (CN) 200910302481.0

(51) Int. Cl. F21V 1/00

(52) U.S. Cl. 362/235

(57) ABSTRACT

A light guiding mechanism includes a cover, a light guide plate, two light sources and a printed circuit board. The cover includes a light transmitting region. The light guide plate includes a first diagonal line, a second diagonal line and a light reflecting region. The light reflecting region is beneath the light transmitting region and includes a matrix of protrusions. The protrusions are arrayed in parallel to the second diagonal line adjacent protrusions have a space therebetween. The spaces uniformly increases with increasing distance from the second diagonal line. The light sources are fixed on the printed circuit board and lie on the second diagonal line of the light guide plate. Light emitted from the light sources is repeatedly reflected by the protrusions and then passing the light transmitting region of the cover.

### BACKGROUND

1. Technical Field

The present disclosure relates to portable electronic devices, particularly, to a light guiding mechanism for use in a portable electronic device.

2. Description of Related Art

Portable electronic devices generally apply electroluminescence panels or light emitting diodes as light sources to improve general overall appeal and attractiveness. However, light intensity becomes weaker with increasing distance from the light sources and the volume and quantity of the light sources in the portable electronic device are limited. Thus, light intensity of the portable electronic device is not uniform.

Therefore, there is room for improvement within the art.

### BRIEF DESCRIPTION OF THE DRAWINGS

Many aspects of the portable electronic device can be better understood with reference to the following drawings. The components in the drawings are not necessarily drawn to scale, the emphasis instead being placed upon clearly illustrating the principles of the portable electronic device, in which:

FIG. 1 is an exploded, schematic view of a portable electronic device incorporating with a light guiding mechanism, in accordance with an exemplary embodiment;

FIG. 2 is a schematic view of a light guide plate showing in FIG. 1;

FIG. 3 is an assembled, schematic view of the portable electronic device; and

FIG. 4 is a partially, cross sectional view of the portable electronic device shown in FIG. 3.

### DETAILED DESCRIPTION

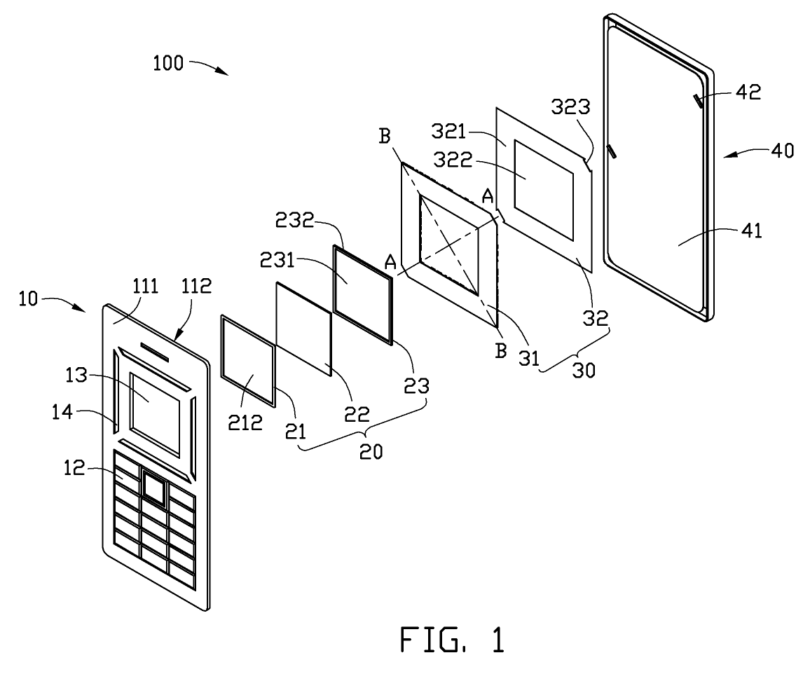

FIG. 1 shows an exemplary embodiment of a portable electronic device 100 incorporating with a light guiding mechanism (not labeled). The portable electronic device 100 includes a cover 10, a display module 20, a light guiding module 30 and a main body 40.

The cover 10 includes an outer surface 111 and an inner surface 112. An input key portion 12 is set in the outer surface 111. The cover 10 defines a display window 13 and a plurality of apertures 14 through the outer surface 111 and the inner surface 112. The apertures 14 are positioned adjacent to the display window 13 to form a light transmitting region (not labeled). In this embodiment, the number of the apertures 14 is four, and the four apertures forms a discontinuous square.

The display module 20 includes a gasket 21, a display 22 and a fixing member 23. The gasket 21 defines a light hole 212 corresponding to the display window 13. The size of the display 22 is similar to the gasket 21. The fixing member 23 includes a base plate 231 and a flange 232. The flange 232 surrounds the base plate 231, for receiving the display 22.

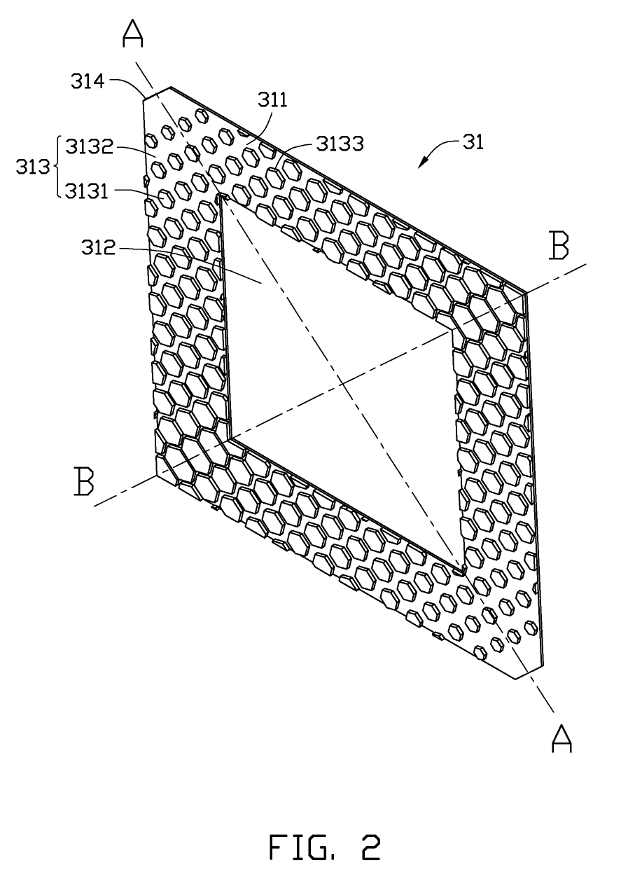

The light guiding module 30 includes a transparent light guide plate 31 and a transparent film 32. Referring to FIG. 2, the light guide plate 31 includes an optical surface 311 and defines a first through hole 312 for receiving the fixing member 23. A pair of diagonally opposite corners of the light guide plate 31 define cutouts, thereby forming two parallel restricting edges. A first diagonal line A-A and a second diagonal line B-B are defined on the optical surface 311. The resisting edges 314 lies on the first diagonal line A-A. The first diagonal line A-A and the second diagonal line B-B are orthogonal to each other. A light reflecting region 313 is formed on the optical surface 311. The light reflecting region 313 includes a matrix of hollow protrusions 3131 aligned parallel to the second diagonal line B-B. Each protrusion 3131 is substantially a hexagonal having three pairs of parallel edges 3133. Adjacent protrusions 3131 are separated from each other, defining a space 3132. The size of the protrusions 3131 uniformly decreases with increasing distance from the second diagonal line B-B. Consequently, the size of the space 3132 uniformly increases with increasing distance from the second diagonal line B-B.

The transparent film 32 has a similar size corresponding to the light guide plate 31, and defines a second through hole 322 corresponding to the first through hole 312. The transparent film 32 has two cutouts 323 at two opposite corners, for receiving two light sources 42 correspondingly.

The main body 40 includes a printed circuit board 41 and the light sources 42 are spacely set on the printed circuit board 41. In this embodiment, the light sources 42 are light emitting diodes.

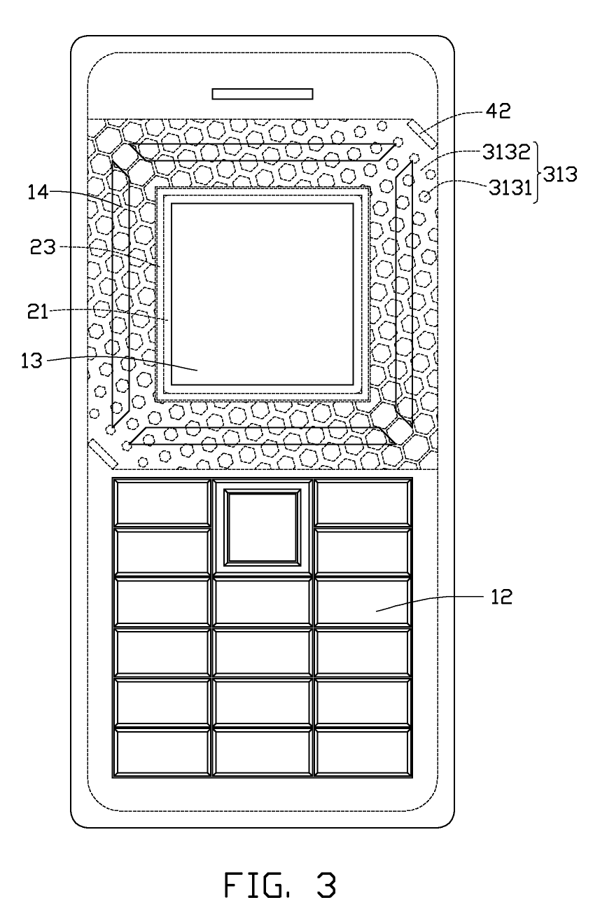

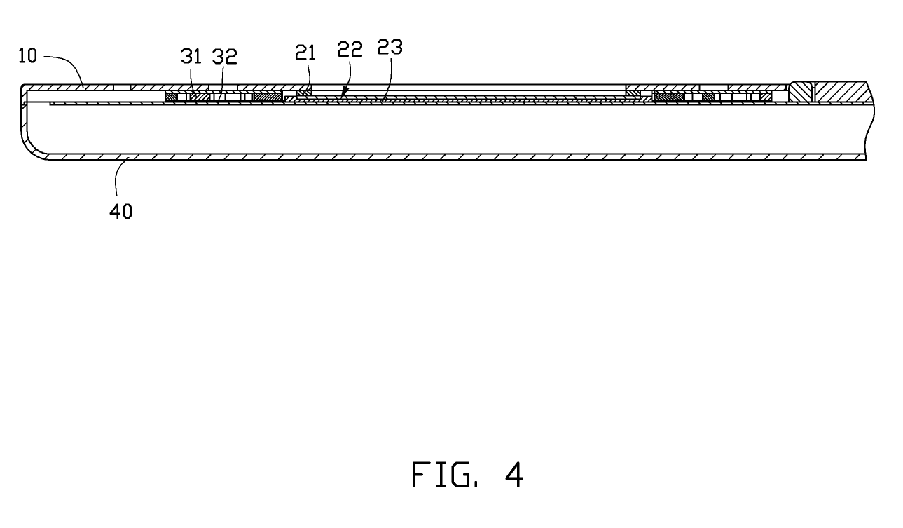

In assembly of the portable electronic device 100, referring to FIGS. 3-4, the transparent film 32 is fixed to the printed circuit board 41, and the cutouts 323 are correspondingly engaged with the light sources 42. The light guide plate 31 is then attached to the transparent film 32, with the protrusions 3131 facing the transparent film 32. The light sources 42 resist the resisting edges 314 of the light guide plate 31 correspondingly. The display 22 is fixed on the fixing member 23, and then the fixing member 23 is received in the first and the second through holes 312, 322 of the light guiding module 30. The gasket 21 is set on the inner surface 112 of the cover 10, around the display window 13. Finally, the cover 10 is attached to the main body 40, with the gasket 21 resisting the display 22 and the light transmitting region corresponding to the reflecting region 313.

When the light sources 42 emit light, light travels through the transparent film 32 and the light reflecting region 313 of the light guide plate 31. The light partially reaches the light reflecting region 313 of the light guide plate 31, and is repeatedly reflected by the protrusions 3131 and the gasket 21. Since the size of the space 3132 uniformly decreases with increasing distance from the light sources 42, reflecting times of the light increase with increasing distance from the light sources 42. Thus, the time of the light staying in the space 3132 increases with increasing distance from the light sources 42, which increases the light intensity. This balances the decrease of light intensity due to a distance from the light sources 42. As a result, the light intensity of the light reflecting region 313 is more uniform, and light uniformly travels out from the apertures 14.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light guiding mechanism for portable electronic device comprising:
a cover includes a light transmitting region;
a light guiding module including a light guide plate, the light guide plate including a light reflecting region and defining a first diagonal line, a second diagonal line; the light reflecting region being beneath the light transmitting region and including a matrix of hollow protrusions, the protrusions being aligned parallel to the second diagonal line, adjacent protrusions having a space therebetween, the size of the space uniformly increasing with increasing distance from the second diagonal line;
two light sources; and
a printed circuit board, the light sources being fixed on the printed circuit board and lying on the second diagonal line of the light guide plate, light emitted from the light sources being repeatedly reflected by the protrusions and then passing the light transmitting region of the cover.

2. The light guiding mechanism as claimed in claim 1, wherein the light guiding module further comprises a transparent film, the transparent film attached to the printed circuit board, and the protrusions of the light guide plate adjacent to the transparent film.

3. The light guiding mechanism as claimed in claim 2, wherein the transparent film comprising two cutouts at a pair of diagonally opposite corners, and the two light sources are respectively received in the two cutouts.

4. The light guiding mechanism as claimed in claim 2, wherein a pair of diagonally opposite corners of the light guide plate defines a cutout, thereby forming two parallel restricting edges, and the two light sources are respectively adjacent to the resisting edges.

5. The light guiding mechanism as claimed in claim 4, further comprising a printed circuit board, wherein the light sources are fixed on the printed circuit board, and the light guiding module is attached to the printed circuit board.

6. The light guiding mechanism as claimed in claim 1, further comprising a display module, wherein the light guiding module defines a through hole, and the display module is received in the through hole.

7. The light guiding mechanism as claimed in claim 6, wherein the display module comprises a gasket, a display and a fixing member, the display is fixed to the fixing member, and the gasket is between the cover and the gasket.

8. The light guiding mechanism as claimed in claim 7, wherein the cover defines a display window corresponding to the display, the light transmitting region including a plurality of apertures around the display window.

9. The light guiding mechanism as claimed in claim 1, wherein the protrusions are hexagonal and includes three pairs of parallel edges.

10. The light guiding mechanism as claimed in claim 1, wherein the light sources are light emitting diodes.

11. A light guiding mechanism for portable electronic device comprising:
a cover includes a light transmitting region;
a light guide plate including a light reflecting region and defining a first diagonal line, a second diagonal line; the light reflecting region being beneath the light transmitting region and including a matrix of protrusions, the protrusions being arrayed in parallel to the second diagonal line, adjacent protrusions having a space therebetween, the spaces uniformly increasing with increasing distance from the second diagonal line;
two light sources; and
a printed circuit board, the light sources being fixed on the printed circuit board and lying on the second diagonal line of the light guide plate, light emitted from the light sources being repeatedly reflected by the protrusions and then passing the light transmitting region of the cover.

12. The light guiding mechanism as claimed in claim 11, further comprising a transparent film, wherein the transparent film is attached to the printed circuit board, and the protrusions of the light guide plate is adjacent to the transparent film.

13. The light guiding mechanism as claimed in claim 12, wherein the transparent film comprising two cutouts at a pair of diagonally opposite corners, and the two light sources are respectively received in the two cutouts.

14. The light guiding mechanism as claimed in claim 12, wherein a pair of diagonally opposite corners of the light guide plate defines a cutout, thereby forming two parallel restricting edges, and the two light sources are respectively adjacent to the resisting edges.

15. The light guiding mechanism as claimed in claim 11, further comprising a display module, wherein the light guiding module defines a through hole, and the display module is received in the through hole.

16. The light guiding mechanism as claimed in claim 15, wherein the display module comprises a gasket, a display and a fixing member, the display is fixed to the fixing member, and the gasket is between the cover and the gasket.

17. The light guiding mechanism as claimed in claim 16, wherein the cover defines a display window corresponding to the display, the light transmitting region including a plurality of apertures around the display window.

18. The light guiding mechanism as claimed in claim 11, wherein the protrusions are hexagonal and includes three pairs of parallel edges.

19. The light guiding mechanism as claimed in claim 11, wherein the light sources are light emitting diodes.
